(19) United States
(12) Patent Application Publication
(10) Pub. No.: US 2017/0300218 A1
(43) Pub. Date: Oct. 19, 2017

(54) VEHICLE DISPLAY CONTROL DEVICE

(71) Applicant: DENSO CORPORATION, Kariya-city, Aichi-pref. (JP)

(72) Inventor: Hiroshi MORIMOTO, Kariya-city (JP)

(21) Appl. No.: 15/511,655

(22) PCT Filed: Sep. 24, 2015
(86) PCT No.: PCT/JP2015/004852

§ 371 Date: Mar. 16, 2017

(30) Foreign Application Priority Data
Oct. 7, 2014 (JP) 2014-206411

(51) Int. Cl. G06F 3/0484; G09G 5/10; B60K 35/00; G09G 5/02; G01C 21/36

(52) U.S. Cl. CPC G06F 3/04847; G01C 21/367; G01C 21/3664; B60K 35/00; G09G 5/02; G09G 5/10; B60K 2350/2008; B60K 2350/1072; B60K 2350/1028; B60K 2350/352; G09G 2320/0666; G09G 2320/08; G09G 2354/00; G09G 2380/10

(57) ABSTRACT

A vehicle display control device is provided for displaying an operation screen with a display device where operation buttons are arranged on the operation screen and it is predetermined for each operation button whether a function is to be validated or invalidated in accordance with how large a load on a driver is. The vehicle display control device includes a valid operation color acquisition unit and a first display unit. The valid operation color acquisition unit uses load level colors as gradually different colors predetermined to correspond to magnitudes of the load on the driver, and acquires valid operation colors as the load level colors that correspond to the loads on the driver when the operation buttons are to be validated. The first display unit displays colors of the operation buttons arranged on the operation screen based on the valid operation colors.

### CROSS-REFERENCE TO RELATED APPLICATION

The present application is based on Japanese Patent Application No. 2014-206411 filed on Oct. 7, 2014, disclosure of which is incorporated herein by reference.

### TECHNICAL FIELD

The present disclosure relates to a vehicle display control device mounted in a vehicle.

### BACKGROUND ART

There has conventionally been known a display device having a navigation function such as, e.g., displaying the position of a subject vehicle or displaying a route to be followed. When an operation, e.g., selecting an item on a menu on an operation screen is performed, the display device performs the function corresponding to the selected item. From a safety point of view, it is not preferable for a driver to perform the operation during driving, while watching the operation screen. Accordingly, there are various proposed technologies to inhibit the driver from performing the operation during driving, while watching the operation screen. Patent Literature 1 proposes a technology which displays menu items on the operation screen such that the disabled menu items are lower in visibility than the enabled menu items.

### PRIOR ART LITERATURE

### Patent Literature

Patent Literature 1: JP2004-309324A

### SUMMARY OF INVENTION

In the technology described above however, it may be possible that the driver has to continue to drive in a state where the driver cannot recognize when a function corresponding to each menu item on the operation screen is to be enabled or disabled.

An object of the present disclosure is to provide a technology which allows a driver to recognize when a function corresponding to each menu item on an operation screen is to be validated or invalidated in accordance with a driving load.

In an aspect of the present disclosure, there is provided a vehicle display control device for displaying an operation screen with a display device where a plurality of operation buttons each to be selected by a user to execute a predetermined function are arranged on the operation screen and it is predetermined for whether the predetermined function corresponding to each operation button is validated or invalidated in accordance with how large a load on a driver is. The vehicle display control device comprises: a valid operation color acquisition unit that uses load level colors, which are gradually different colors and are predetermined to correspond to magnitudes of the load on the driver, and acquires valid operation colors, which are the load level colors that correspond to the loads on the driver when the operation buttons are to be validated; and a first display unit that displays colors of the operation buttons arranged on the operation screen based on the valid operation colors.

In such a configuration, the operation buttons are displayed in the valid operation colors among the load level colors. Thus, in accordance with such a configuration, the operation buttons are displayed based on the color corresponding to the load on the driver when the operation button is to be validated. This can allow the driver to recognize when the operation button is to be validated or invalidated in accordance with the driving load.

### BRIEF DESCRIPTION OF DRAWINGS

The above and other objects, features and advantages of the present disclosure will become more apparent from the following detailed description made with reference to the accompanying drawings. In the drawings:

FIG. 1 is a block diagram illustrating a configuration of a vehicle display system;

FIG. 2 is a view illustrating an example of the state of a driving load;

FIG. 3 is a flow chart of a display setting process performed by a navigation ECU;

FIG. 4 is a view illustrating an example of an operation screen in accordance with the state of the driving load in a first embodiment;

FIG. 5 is a view illustrating an example of the operation screen in accordance with the state of the driving load in a second embodiment;

FIG. 6 is a view illustrating an example of the operation screen in accordance with the state of the driving load in a third embodiment; and

FIG. 7 is a view illustrating another embodiment with regard to an image device displaying the operation screen.

### EMBODIMENTS FOR CARRYING OUT INVENTION

The following will describe embodiments with reference to the drawings.

### 1. First Embodiment

1-1. Configuration

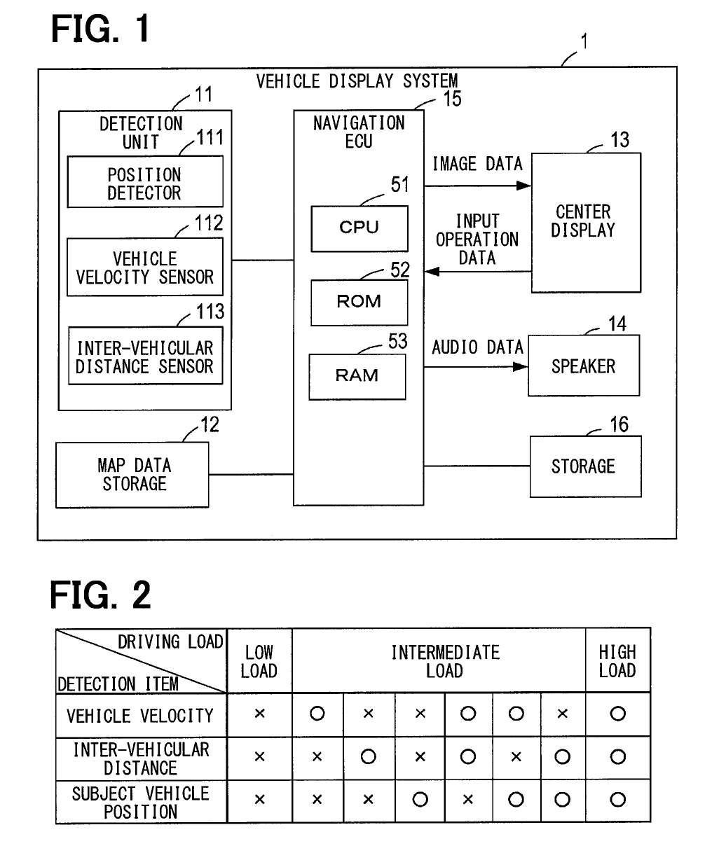

A vehicle display system 1 shown in FIG. 1 is mounted in a vehicle and includes a detection unit 11, a map data storage 12, a center display 13, a speaker 14, and a navigation ECU 15.

The detection unit 11 detects the state of the vehicle using various devices, sensors, and the like. By way of example, the detection unit 11 includes a position detector 111, a vehicle velocity sensor 112, and an inter-vehicular distance sensor 113.

The position detector 111 includes a GPS receiver, a gyroscope, and a distance sensor which are not shown. The GPS receiver receives a transmission signal from a GPS (Global Positioning System) satellite and detects the coordinate and height of the position of a subject vehicle (vehicle in which the vehicle display system 1 is mounted). The gyroscope outputs a detection signal in accordance with the angular velocity of a rotary movement of the subject vehicle. The distance sensor outputs the traveling distance of the subject vehicle. The position detector 111 calculates the current position of the subject vehicle based on respective output signals from the individual sensors.

The vehicle velocity sensor 112 detects the rotative velocity of a tire wheel of the subject vehicle using a pulse generator attached to the tire wheel and calculates the velocity of the subject vehicle based on the detected rotative velocity.

The inter-vehicular distance sensor 113 transmits an electric wave from a radar disposed ahead of the vehicle and not shown and detects the inter-vehicular distance between the subject vehicle and a proceeding vehicle based on the result of receiving a reflected wave from a target object located ahead of the vehicle.

The map data storage 12 is a storage device in which map data showing a map is stored. The map data includes, as information about roads on which motor vehicles can travel, information showing road types (expressways (including a pay road and a road exclusively for motor vehicles)/national routes/other general roads, etc.), information showing curved roads, and the like. The map data in the present embodiment also includes information showing high-load areas as regions where a load on a driver (hereinafter simply referred to as a driving load) increases. It is assumed that the high-load area refers to a region where a driver should be concentrated on a predetermined driving operation while driving in the region. Specific examples of the high-load area include a region where the driver should be concentrated on a brake operation due to a traffic jam or the like, a region where the driver should be concentrated on a steering operation and a brake operation due to a sharp curve or the like, a region where a road width is small and the driver should be concentrated on an accelerator operation and a brake operation, and the like. The high-load areas are predetermined based on brake pedal depression, a steering operation (rudder angle), an accelerator position, an acceleration rate, an inter-vehicular time as a value obtained by dividing the inter-vehicular distance by the vehicle velocity, and the like.

The center display 13 is a display device to be visually recognized by a plurality of occupant of the subject vehicle including the driver, e.g., the driver, the passenger on the front passenger seat, and the like. The center display 13 is placed at the center portion of an instrument panel (dashboard).

The center display 13 is a touch-panel liquid crystal display and displays an operation screen provided by image data input from the navigation ECU 15. On the operation screen, a plurality of operation buttons are arranged. When the occupant selects any of the operation buttons, the center display 13 outputs input operation data showing which one of the operation buttons has been selected to the navigation ECU 15.

The speaker 14 is an output device provided in the vehicle interior to output a sound to the occupants of the subject vehicle including a user, i.e., the driver. The speaker 14 outputs speech for routing assistance included in a navigation function, music included in an audio function, and the like which are shown by audio data input from the navigation ECU 15.

The navigation ECU 15 is an electronic control unit including a CPU 51, a ROM 52, a RAM 53, and the like. The CPU 51 performs various processes in accordance with the programs stored in storage media such as the ROM 52 to carry out integrated control of the vehicle display system 1.

The navigation ECU 15 performs processes for implementing the navigation function such as, e.g., the process of specifying the position of the subject vehicle on a map, the process of searching for a route to a set destination, and the process of providing routing assistance in accordance with the searched route. The navigation ECU 15 also performs processes for implementing the audio function such as, e.g., the process of turning ON/OFF the audio function and the process of outputting music.

When the user selects any of the operation buttons arranged on the operation screen of the center display 13, the navigation ECU 15 performs a predetermined function (process) corresponding to the selected operation button based on the input operation data. In the present embodiment, a condition for validating and invalidating the function corresponding to the selected operation button is predetermined in accordance with how large the driving load is. In the below, enabling the function corresponding to the operation button is also referred to as validating the operation button, and, disabling the function corresponding to the operation button is also referred to as invalidating the operation button.

From a safety point of view, it is not preferable that a driver perform an operation while watching the operation screen for a long time. Accordingly, in the present embodiment, the navigation ECU 15 invalidates a function which requires a driver to take longer time to watch the operation screen as the driving load in the subject vehicle is larger. The following illustrates the driving load in three different states, i.e., a low-load state, an intermediate-load state, and a high-load state which are arranged in order of increasing load. The low-load validated function refers to a function that is validated when the driving load is equal to or lower than the low-load state. An intermediate-load validated function refers to a function that is validated when the driving load is equal to or lower than the intermediate-load state. A high-load validated operation refers to a function that is validated when the driving load is equal to or lower than the high-load state. Examples of the low-load validated operation include a destination setting function included in the navigation function which requires the driver to take long time to watch the operation screen and the like. Examples of the high-load validated operation include a function of turning ON the audio function which does not require the driver to take a long time to watch the operation screen and the like.

By way of example, the navigation ECU 15 specifies any of the three states, i.e., the low-load state, the intermediate-load state, and the high-load state as the state of the driving load in the subject vehicle based on the output from the detection unit 11 and outputs the result of the specifying. Specifically, the navigation ECU 15 determines whether or not the result of detection is not less than a predetermined threshold value for each of three detection items, i.e., vehicle velocity, inter-vehicular distance, and subject vehicle position which are detected by the detection unit 11. The navigation ECU 15 specifies a current driving load based on, among the detection items, how many the detection result is not less than the predetermined threshold value. For the subject vehicle position, when the detected subject vehicle position is located in the high-load area shown in the map data storage 12, it is determined that the detection result is not less than the threshold value.

In FIG. 2 shown by way of example, the detection item with the mark “o” indicates that the detection result of this detection item is not less than the predetermined threshold value. In the present embodiment, it is specified that the driving load is in the high-load state when the detection results for the three detection items are not less than the threshold values. It is also specified that, when the detection result for one or two of the three detection items is not less than the threshold value, the driving load is in the intermediate-load state. When the detection results for the three detection items are less than the threshold values, the driving load is in the low-load state. For example, it is specified that, when stopped at a location outside the high-load area, the subject vehicle is in the low-load state.

The navigation ECU 15 performs a display setting process of setting the display mode of the operation screen on which the plurality of operation buttons are arranged.

As described above, the storage 16 pre-stores an association between the function corresponding to a respective operation button and one of the low-load validated operation, the intermediate-load validated operation, and the high-load validated operation. The storage 16 also pre-stores load level colors, valid operation colors, and the like described later.

1-2. Process

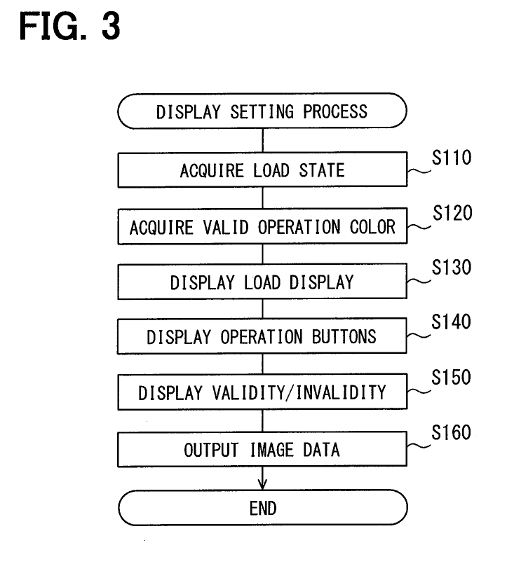

Next, an example of the display setting process performed by the CPU 51 of the navigation ECU 15 will be described with reference to the flow chart shown in FIG. 3. Note that the display setting process is repeatedly performed at predetermined time intervals while an ACC switch is ON.

In S (Step) 110, the navigation ECU 15 acquires the state of the driving load. Specifically, the navigation ECU 15 acquires information showing which one of the low-load state, the intermediate-load state, and the high-load state the driving load is specified as the state of the driving load. As described above, the navigation ECU 15 specifies the driving load state in the process other than this display setting process.

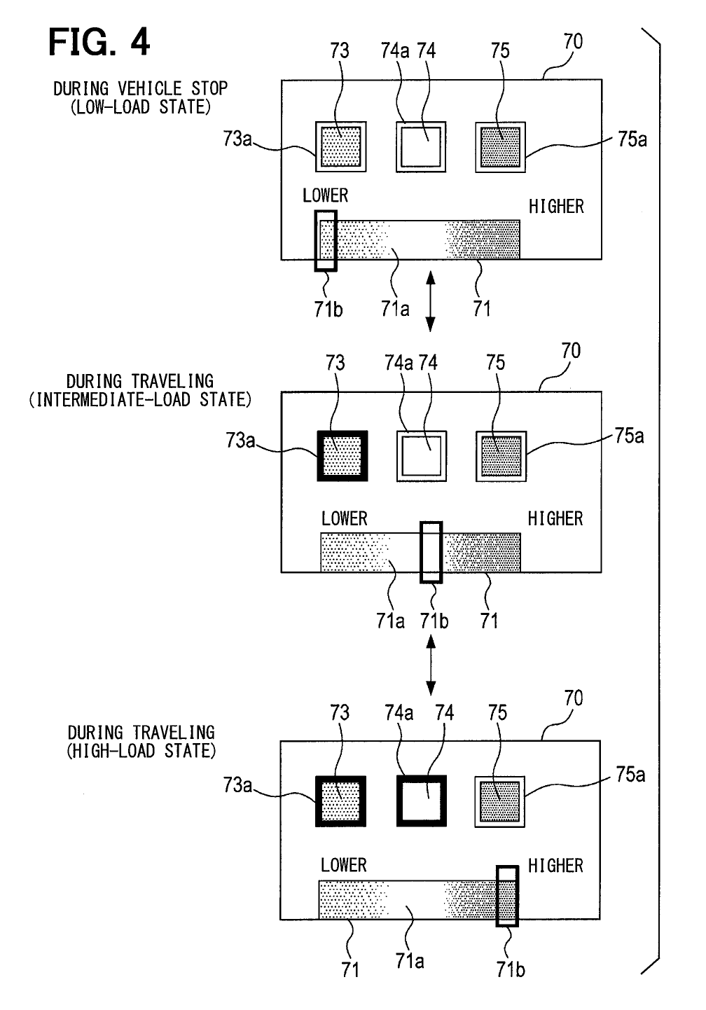

Subsequently, in S120 to S150, the navigation ECU 15 generates image data for causing the center display 13 to display the operation screen. Now, the description will be given with reference to an operation screen 70 which displays a plurality of operation buttons 73 to 75 and a load display 71 indicating how large a current driving load is, as shown by way of instance in FIG. 4. It is assumed that the function corresponding to the operation button 73 is the low-load validated function, the function corresponding to the operation button 74 is the intermediate-load validated function, and the operation corresponding to the operation button 75 is the high-load validated function.

First, in S120: a plurality of gradually different gradually predetermined to correspond to the magnitudes of the driving load are used as load level colors; the load level colors that correspond to the driving loads when the predetermined functions corresponding to the operation buttons are to be validated are used as valid operation colors; and the valid operation colors are acquired. Specifically, in the present embodiment, red, yellow, and green colors are determined as the three load level colors by way of example. It is determined that the low-load state is represented by green, the intermediate-load state is represented by yellow, and the high-load state is represented by red. That is, it is predetermined that the valid operation color of the operation button 73 for the low-load validated operation is green, the valid operation color of the operation button 74 for the intermediate-load validated operation is yellow, and the valid operation color of the operation button 75 for the high-load validated operation is red. Note that the association between the operation buttons 73 to 75 and the valid operation colors are stored in the storage 16, as described above.

Next, in S130, the navigation ECU 15 generates image data for displaying the load display 71 by using the one of the load level colors which corresponds to the driving load, where the load display 71 shows the magnitude of the driving load acquired by S110. The driving load acquired by S110 is hereinafter referred to as the current driving load. Specifically, the navigation ECU 15 shows, as the load display 71, a load level color display 71a and a load corresponding color display 71b. In the load level color display 71a, the load level colors are arranged in order corresponding to an increase in driving load. The load corresponding color display 71b shows which color in the load level color display 71a corresponds to the current driving load.

Subsequently, in S140, the navigation ECU 15 generates image data of the operation buttons 73 to 75 arranged on the operation screen 70. Specifically, the navigation ECU 15 displays the respective main bodies of the operation buttons 73 to 75 in the colors based on the valid operation colors. The present embodiment generates the image data for displaying the operation buttons 73 to 75 successively in green, yellow, and red using the respective valid operation colors.

Next, in S150, the navigation ECU 15 displays the operation buttons 73 to 75 in different modes depending on whether or not the functions corresponding to the operations buttons 73 to 75 are valid under the current driving load. In the present embodiment, when the predetermined function corresponding to the operation button is invalid, the operation button is displayed using a lower brightness color than when the predetermined operation corresponding to the operation button is valid. Specifically, the navigation ECU 15 displays the operation buttons in such a manner as to add a white outer frame around the operation button for which the corresponding operation is valid under the current driving load and add a black outer frame around the operation button for which the corresponding operation is invalid under the current driving load. Black is a color having a lower brightness than white.

Finally, in S160, the navigation ECU 15 outputs the generated image data to the center display 13 and ends the present display setting process.

1-3. Function

The function of the vehicle display system 1 will be described using FIG. 4 shown by way of example. It is assumed that, in FIG. 4, the operation button (main body) 73 is shown in green, the operation button 74 is sown in yellow, and the operation button 75 is shown in red.

The upper portion of FIG. 4 shows an example of the operation screen 70 when the driving load is in the low-load state. At this time, the load display on the operation screen 70 is shown such that the load corresponding color display 71b overlaps the portion of the load level color display 71a which is shown in green as the color corresponding to the low-load state. In the low-load state, each of the function corresponding to the operation buttons 73 to 75 is valid. Accordingly, white outer frames 73a to 75a are respectively shown around the operation buttons 73 to 75.

The middle portion of FIG. 4 shows an example of the operation screen 70 when the driving load is in the intermediate-load state. At this time, the load display 71 on the operation screen 70 is shown such that the load corresponding color display 71b overlaps the portion of the load level color display 71a which is shown in yellow as the color corresponding to the intermediate-load state. In the intermediate-load state, the function corresponding to the operation button 73 is invalid, while the functions corresponding to the operation buttons 74 and 75 are valid. Accordingly, the black outer frame 73a is shown around the operation button 73, while the white outer frames 74a and 75a are respectively shown around the operation buttons 74 and 75.

The lower portion of FIG. 4 shows an example of the operation screen 70 when the driving load is in the high-load state. At this time, the load display 71 on the operation screen 70 is shown such that the load corresponding color display 71b overlaps the portion of the load level color display 71a which is shown in red as the color corresponding to the high-load state. In the high-load state, the functions corresponding to the operation buttons 73 and 74 are invalid, while the function corresponding to the operation button 75 is valid. Accordingly, the black outer frames 73a and 74a are respectively shown around the operation buttons 73 and 74, while the white outer frame 75a is shown around the operation button 75.

1-4. Advantages

According to the embodiment described heretofore in detail, the following advantages can be obtained.

The operation buttons 73 to 75 are displayed based on the colors corresponding to the driving loads when the operation buttons 73 to 75 are to be validated. This allows the driver to recognize when the operation buttons 73 to 75 are to be validated or invalidated in accordance with the driving load. In addition, it is possible to allow the driver to recognize when the operation buttons 73 to 75 are to be validated or invalidated in accordance with the driving load without causing the driver to watch the operation screen 70 for a long time. As a result, it is possible to allow the driver to recognize that the invalidated operation button can be validated when, e.g., the driving load is reduced in such a manner that, e.g., the vehicle velocity is reduced or the inter-vehicular distance is increased.

The load display 71 shows how large the driving load is, by using the one of the load level colors which corresponds to the driving load. This allows the driver to recognize the current driving load without causing the driver to watch the operation screen 70 for a long time.

The load display 71 is included in the operation screen 70. This allows the driver to easily compare the color of the current driving load to the colors of the operation buttons 73 to 75. That is, it becomes possible for the driver to easily recognize how large the current driving load is, and to easily recognize the magnitudes of the loads for validating the operation buttons 73 to 75.

The load display 71 includes the load level color display 71a in which the load level colors are arranged in order corresponding to an increasing in the magnitude of the driving load. This allows the driver to easily recognize whether each of the operation buttons 73 to 75 is to be validated when the driving load is small or validated even when the driving load is large. This also allows the driver to easily recognize whether the color of the operation button which is conceivably to be used is closer to the color of the driving load larger than the current driving load or to the color of the driving load smaller than the current driving load and also easily determine whether or not the driving load is to be reduced so as to use the operation button.

The load display 71 includes the load corresponding color display 71b which shows which color in the load level color display 71a corresponds to the current driving load acquired by S110. This allows the driver to easily recognize how large the current driving load is.

Depending on whether or not the operation buttons 73 to 75 are valid when the current driving load is acquired, the operation buttons 73 to 75 are displayed in different modes. This allows the driver to easily recognize the operation button which is valid under the current driving load.

When the operation buttons 73 to 75 are invalid, the operation buttons 73 to 75 are shown using colors having lower brightness than when the operation buttons 73 to 75 are valid. For example, when the operation buttons 73 to 75 are invalid, the operation buttons 73 to 75 are shown with the black frames added therearound. This allows the driver to clearly distinguishably recognize the valid operation button and the invalid operation button.

Note that, in the present embodiment, the navigation ECU 15 corresponds to an example of a vehicle display control device and the center display 13 corresponds to an example of a display device. Also, S110 corresponds to an example of a process of a load acquisition unit, S120 corresponds to an example of a process of a valid operation color acquisition unit, S140 corresponds to an example of a process of a first display unit, and S130 corresponds to an example of a process of a second display unit. Also, S150 corresponds to an example of a process of a third display unit.

### 2. Second Embodiment

2-1. Configuration

A second embodiment has the same basic configuration as that of the first embodiment. Accordingly, a description of common components is omitted and the second embodiment will be described with a focus on the difference from the first embodiment.

In the first embodiment described above, the colors of the main bodies of the operation buttons 73 to 75 are used as the valid operation colors. However, the present embodiment is different from the first embodiment in that the colors of the outer frames of the operation buttons 73 to 75 are used as the valid operation colors. Also, in the first embodiment, the white outer frame is added around the valid operation buttons 73 to 75 and the black outer frame is added around the invalid operation buttons 73 to 75. However, the present embodiment is different from the first embodiment in that the main body of the invalid operation button 73 to 75 is provided with a color different from the color of the main body of the valid operation button 73 to 75.

2-2. Process

In the display setting process executed by the navigation ECU 15 in the present embodiment, the content of the process in S140 to S150 is different from that in the display setting process in the first embodiment shown in FIG. 3. In S110 to S130 and S160, the same process as that in the display setting process in the first embodiment is performed.

In S140, the navigation ECU 15 generates image data of the operation buttons 73 to 75 arranged on the operation screen 70. Specifically, the navigation ECU 15 displays the respective outer frames of the individual operation buttons 73 to 75 in the colors based on the valid operation colors of the individual operation buttons 73 to 75. That is, by way of example, the navigation ECU 15 generates the image data such that the outer frame 73a of the operation button 73 is shown in green, the outer frame 74a of the operation button 74 is shown in yellow, and the outer frame 75a of the operation button 75 is shown in red.

In S150, the navigation ECU 15 displays the respective main bodies of the operation buttons 73 to 75 in different modes depending on whether or not the operation buttons 73 to 75 are valid under the current driving load. Specifically, the navigation ECU 15 causes the main body of the operation button, i.e., the inside of the outer frame of the operation button which is valid under the current driving load to be shown in blue by way of example and causes the main body of the operation button which is invalid under the current driving load to be shown in gray by way of example.

2-3. Function

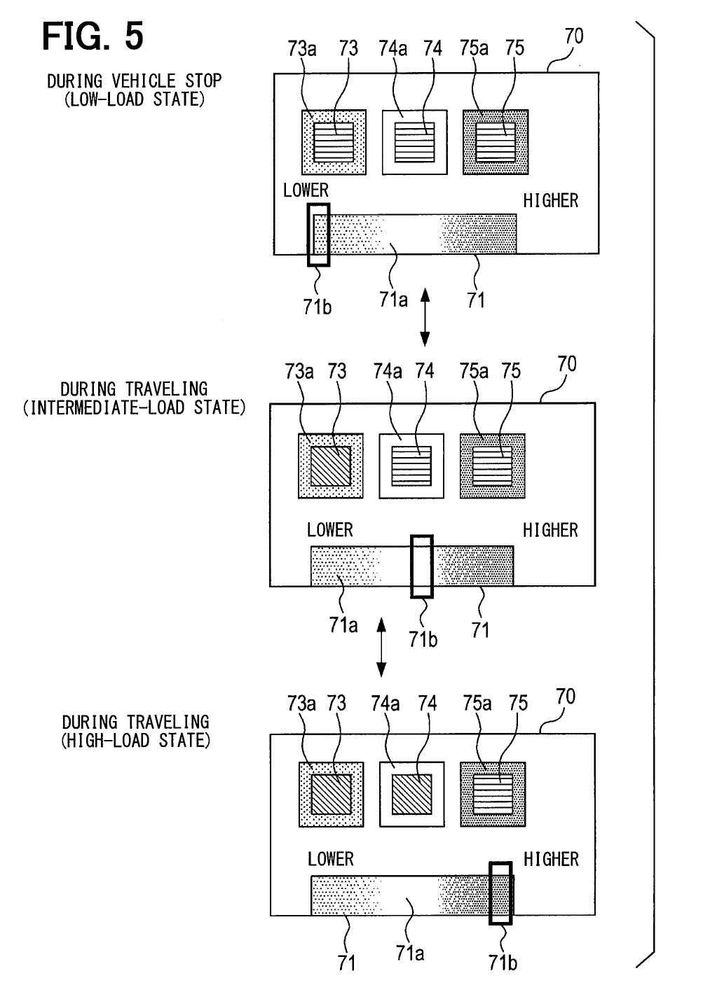

The function of the vehicle display system 1 will be described using FIG. 5 shown by way of example. In FIG. 5, the outer frame 73a of the operation button 73 is shown in green, the outer frame 74a of the operation button 74 is shown in yellow, and the outer frame 75b of the operation button 75 is shown in red. Also, in FIG. 5, the load display 71 is shown in the lower part of the operation screen 70.

The upper portion of FIG. 5 shows an example of the operation screen 70 when the driving load is in the low-load state. At this time, the load display 71 of the operation screen 70 is shown such that the load corresponding color display 71b overlaps the portion of the load level color display 71a which is shown in green as the color corresponding to the low-load state. In the low-load state, each of the operation buttons 73 to 75 is valid. Accordingly, the main bodies of the operation buttons 73 to 75 are shown in blue.

The middle portion of FIG. 5 shows an example of the operation screen 70 when the driving load is in the intermediate-load state. At this time, the load display 71 of the operation screen 70 is shown such that the load corresponding color display 71b overlaps the portion of the load level color display 71a which is shown in yellow as the color corresponding to the intermediate-load state. In the intermediate-load state, the operation button 73 is invalid, while the operation buttons 74 and 75 are valid. Accordingly, the main body of the operation button 73 is shown in gray, while the main bodies of the operation buttons 74 and 75 are shown in blue.

The lower portion of FIG. 5 shows an example of the operation screen 70 when the driving load is in the high-load state. At this time, the load display 71 of the operation screen 70 is shown such that the load corresponding color display 71b overlaps the portion of the load level color display 71a which is shown in red as the color corresponding to the high-load state. Also, in the high-load state, the operation buttons 73 and 74 are invalid, while the operation button 75 is valid. Accordingly, the main bodies of the operation buttons 73 and 74 are shown in gray, while the main body of the operation button 75 is shown in blue.

2-4. Advantages

According to the embodiment described heretofore in detail, the same advantages as obtained in the first embodiment described above can be obtained.

### 3. Third Embodiment

3-1. Configuration

A third embodiment has the same basic configuration as that of the second embodiment. Accordingly, a description of common components is omitted and the third embodiment will be described with a focus on the difference from the second embodiment.

In the second embodiment described above, the load display 71 including the load level color display 71a and the load corresponding color display 71b shows how large the current driving load is. However, the mode in which the current driving load is displayed is different from that in the second embodiment.

3-2. Process

In the display setting process performed by the navigation ECU 15 in the present embodiment, the content of the process in S130 is different from that in the display setting process in the second embodiment described above. In S110, S120, and S140 to S160, the same process as that in the display setting process in the second embodiment is performed.

In S130, the navigation ECU 15 generates image data for the load display to show how large the driving load acquired by S110 is, by using the one of the load level colors that corresponds to the driving load. Specifically, the navigation ECU 15 displays the same load level color display 71a as in the foregoing embodiment on the operation screen 70. The navigation ECU 15 also displays the background of the operation screen 70 using the load corresponding color as the one of the load level colors which corresponds to the current driving load. Thus, in the present embodiment, which color in the load level color display 71a corresponds to the current driving load is shown by the color of the background of the operation screen 70. That is, the load corresponding color display 71b in the foregoing embodiment corresponds to the background color of the operation screen 70 in the present embodiment.

3-3. Function

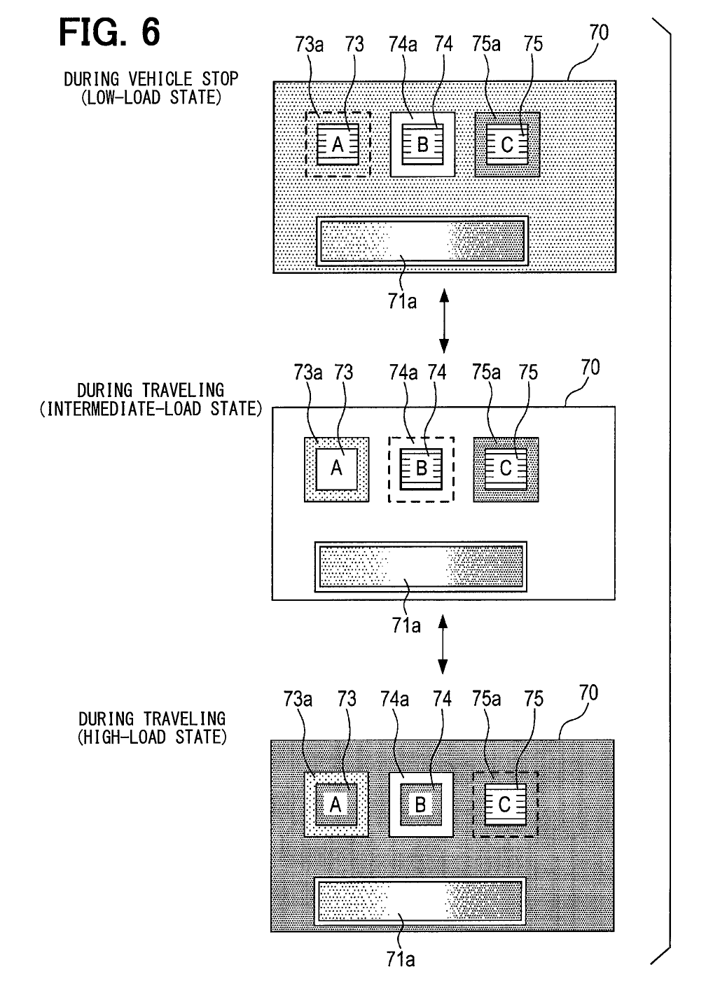

The function of the vehicle display system 1 will be described using FIG. 6 shown by way of example. In FIG. 6, the outer frame 73a of the operation button 73 is shown in green, the outer frame 74a of the operation button 74 is shown in yellow, and the outer frame 75b of the operation button 75 is shown in red. Also, in FIG. 6, the load level color display 71a is shown in the lower part of the operation screen 70.

The upper portion of FIG. 6 shows an example of the operation screen 70 when the driving load is in the low-load state. At this time, the background of the operation screen 70 is shown in green as the color corresponding to the current driving load (low-load state). Also, at this time, the outer frame 73a of the operation button 73 is shown in the same color as that of the background of the operation screen 70 and displayed in a mode different from that of each of the other operation buttons 74 and 75. In the same manner as in the second embodiment, in the low-load state, each of the operation buttons 73 to 75 is valid. Accordingly, the main bodies of the operation buttons 73 to 75 are shown in blue.

The middle portion of FIG. 6 shows an example of the operation screen 70 when the driving load is in the intermediate-load state. At this time, the background of the operation screen 70 is shown in yellow as the color corresponding to the current driving load (intermediate-load state). At this time, the outer frame 74a of the operation button 74 is shown in the same color as that of the background of the operation screen 70 and displayed in a form different from that of each of the other operation buttons 73 and 75. In the same manner as in the second embodiment, in the intermediate-load state, the operation button 73 is invalid, while the operation buttons 74 and 75 are valid. Accordingly, the main body of the operation button 73 is shown in gray, while the main bodies of the operation buttons 74 and 75 are shown in blue.

The lower portion of FIG. 6 shows an example of the operation screen 70 when the driving load is in the high-load state. At this time, the background of the operation screen 70 is shown in red as the color corresponding to the current driving load (high-load state). At this time, the outer frame 75a of the operation button 75 is shown in the same color as that of the background of the operation screen 70 and displayed in a mode different from that of each of the other operation buttons 73 and 74. In the same manner as in the second embodiment, in the high-load state, the operation buttons 73 and 74 are invalid, while the operation button 75 is valid. Accordingly, the main bodies of the operation buttons 73 and 74 are shown in gray, while the main body of the operation button 75 is shown in blue.

3-4. Advantages

According to the embodiment described heretofore in detail, in addition to the same advantages as obtained in the second embodiment described above, the following advantages can be obtained.

On the operation screen 70, the load level color display 71a is shown, and the background of the operation screen 70 is shown in a color corresponding to the current driving load. That is, the color corresponding to the current driving load is shown in a large area. This allows the driver to more easily recognize how the current driving load corresponding to the background color of the operation screen 70 is to be changed to validate the operation buttons 73 to 75.

### 4. Other Embodiments

While the embodiments have been shown heretofore by way of example, the embodiments are not limited to the foregoing and include various embodiments.

In each of the foregoing embodiments, the modes of display of the operation buttons 73 to 75, the load display 71, and the like on the operation screen 70 are only exemplary. The modes of display of the operation buttons 73 to 75 and the load display 71, e.g., various modes of the number, shapes, and arrangement thereof may be set as appropriate.

In each of the foregoing embodiments, the operation buttons 73 to 75 are shown using the respective valid operation colors, but the display of the operation buttons 73 to 75 is not limited thereto. For example, each of the operation buttons 73 to 75 may also be shown based on the valid operation color, specifically by using the color corresponding to a driving load larger than the driving load corresponding to the valid operation color by a predetermined magnitude. In this case, it is possible for the driver to recognize that the operation buttons 73 to 75 are validated under driving loads lower than the driving loads corresponding to the colors of the operation buttons 73 to 75.

Alternatively, a plurality of gradually different colors each predetermined to correspond to different magnitudes of the load on the driver may be used as load level colors. The load level colors that correspond to the loads on the driver when the operation buttons are to be invalidated may be used as the invalid operation colors. The colors of the operation buttons arranged on the operation screen may be displayed based on the invalid operation colors.

In each of the foregoing embodiments, by way of example, the load level colors are set to green, yellow, and red in order corresponding to an increase in load. However, the combination and arrangement of these colors are only exemplary. The load level colors may also be set to any different colors and may also be set so as to be arranged in any order. The load level colors may also be set using the gray scale (gradation) of a color.

In each of the foregoing embodiments, the navigation ECU 15 specifies any of the three states, i.e., the low-load state, the intermediate-load state, and the high-load state as the state of the driving load. However, the number of driving load states is not limiting and may be set as appropriate. In accordance with this, the load level colors may also be set as appropriate.

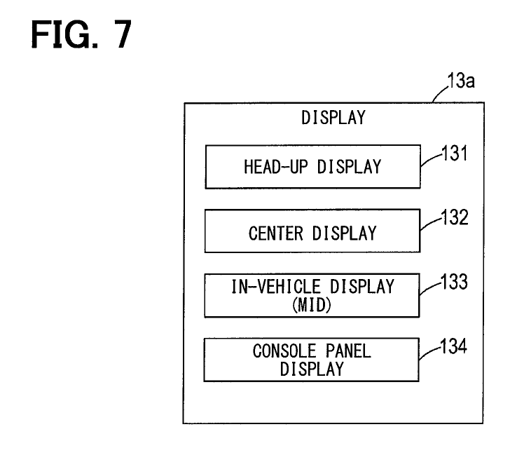

In each of the foregoing embodiments, the operation screen 70 is shown on the center display 13, but this is not limiting. For example, the vehicle display system 1 may also include a display 13a having a plurality of devices capable of showing the image of image data, and the operation screen 70 may also be shown on any of these devices. In FIG. 7 shown by way of example, the display 13a included in the vehicle display system 1 has a known head-up display 131, a center display 132 as described above, an in-vehicle display 133 disposed separately from the center display 132 in the vicinity of the position where the center display 132 is disposed, a console panel display 134 as a display on a console panel which shows various meters, and the like. The operation screen on which the operation buttons are arranged may also be shown on any of these devices. It may also be possible that the operation buttons are shown on one of these devices, while the load display is shown on another of the devices.

In each of the foregoing embodiments, the destination setting operation included in the navigation function is shown as an example of the low-load validated operation and the operation of turning ON/OFF the audio function is shown as an example of the high-load validated operation. However, these do not limit low-load validated operation and the high-load validated operation. Any type of operation performed by a user on a vehicle may be the low-load validated operation, the intermediate-load validated operation, or the high-load validated operation on the operation screen 70 of the center display 13.

In each of the foregoing embodiments, the detection unit 11 includes the position detector 111, the vehicle velocity sensor 112, and the inter-vehicular distance sensor 113. However, this does not limit the components of the detection unit 11. Besides, the detection unit 11 may also include, e.g., a steering angle sensor which detects the steering angle of a steering wheel, a sensor which detects an accelerator position, an acceleration sensor which detects an acceleration rate, and the like.

In each of the foregoing embodiments, the high-load areas are predetermined and stored in the map data storage 12. However, when, e.g., the vehicle display system 1 includes a communication unit, the map data storage 12 may also be configured to store information on the high-load areas acquired by the communication unit from outside as necessary. Alternatively, the high-load area with a plurality of different level steps corresponding to the driving load states may be stored.

It may also be possible that the functions of one component in each of the foregoing embodiments are distributed to a plurality of components or the functions of a plurality of components are incorporated into one component. Alternatively, it may also be possible that at least a part of the configuration of each of the foregoing embodiments is replaced by a configuration having the same function. Alternatively, it may also be possible that a part of the configuration of each of the foregoing embodiments is omitted. Alternatively, it may also be possible that at least a part of the configuration of each of the foregoing embodiments is added to or substituted into the configuration of another of the foregoing embodiments. Note that all aspects included in the technical idea of the present disclosure are embodiments

Embodiments may be in various forms including not only the vehicle display system 1 and the navigation ECU 15 each described above, but also a program for causing the navigation ECU 15 to function, a non-transitory storage medium storing therein the program, a display processing method, and the like.

What is claimed is:

1. A vehicle display control device for displaying an operation screen with a display device where a plurality of operation buttons each to be selected by a user to execute a predetermined function are arranged on the operation screen and it is predetermined for whether the predetermined function corresponding to each operation button is validated or invalidated in accordance with how large a load on a driver is, the vehicle display control device comprising:
a valid operation color acquisition unit that
uses load level colors, which are gradually different colors and are predetermined to correspond to magnitudes of the load on the driver, and
acquires valid operation colors, which are the load level colors that correspond to the loads on the driver when the operation buttons are to be validated; and
a first display unit that displays colors of the operation buttons arranged on the operation screen based on the valid operation colors.

2. The vehicle display control device according to claim 1, further comprising:
a load acquisition unit that acquires the load on the driver; and
a second display unit that displays a load display showing how large the load on the driver acquired by the load acquisition unit is, by using one of the load level colors that corresponds to the load on the driver.

3. The vehicle display control device according to claim 2, wherein
the second display unit displays the load display on at least part of the operation screen.

4. The vehicle display control device according to claim 2, wherein
the load display includes a load level color display in which the load level colors are arranged in order corresponding to an increasing in the magnitude of the load on the driver.

5. The vehicle display control device according to claim 4, wherein
the load display includes a load corresponding color display showing which color in the load level color display corresponds to the load on the driver acquired by the load acquisition unit.

6. The vehicle display control device according to claim 1, further comprising:
a load acquisition unit that acquires the load on the driver; and
a third display unit that displays the operation buttons in different modes in accordance with whether or not the operation buttons are valid when the load acquisition unit acquires the load on the driver.

7. The vehicle display control device according to claim 6, wherein
the third display unit displays the invalid operation button in lower brightness color than the valid operation button.
